(19) United States
(12) Patent Application Publication
(10) Pub. No.: US 2011/0131330 A1
(43) Pub. Date: Jun. 2, 2011

(54) COLLOCATING DESKTOP VIRTUAL MACHINES TO PROXIMITY OF THE USER

(75) Inventors: Kirk A. Beaty, Goldens Bridge, NY (US); Andrzej Kochut, Elmsford, NY (US); Carl J. Kraenzel, Boston, MA (US); Sambit Sahu, Hopewell Junction, NY (US); Charles O. Schulz, Ridgefield, CT (US); Hidayatullah Shaikh, Mohegan Lake, NY (US); Shou Hui Wang, Beijing (CN)

(73) Assignee: INTERNATIONAL BUSINESS MACHINES CORPORATION, Armonk, NY (US)

(21) Appl. No.: 12/629,462

(22) Filed: Dec. 2, 2009

(51) Int. Cl. G06F 15/16; G06F 9/455

(52) U.S. Cl. 709/227; 718/1

(57) ABSTRACT

A plurality of master desktop images for a plurality of users are stored at a plurality of geographically diverse data centers. At a first one of the data centers, a virtual desktop is constructed for a remote client. The virtual desktop is constructed from a given one of the master desktop images at the first one of the data centers and an individualized delta image for a user associated with the remote client. When it is determined that the remote client is at a geographical location wherein the first one of the data centers is not the closest one of the data centers to the remote client, the virtual desktop for the remote client is reconstructed at a second, closest, one of the data centers. The virtual desktop is reconstructed from a given one of the master desktop images at the second one of the data centers and the individualized delta image for the user associated with the remote client. A copy of the individualized delta image is moved from the first one of the data centers to the second one of the data centers to facilitate reconstructing the virtual desktop.

### FIELD OF THE INVENTION

The present invention relates to the electrical and electronic arts, and, more particularly, to information technology (IT) and the like.

### BACKGROUND OF THE INVENTION

Desktop virtualization is emerging as an alternative to traditional desktop delivery. The basic concept of desktop virtualization is based on moving the operating system (OS) and application execution from devices which are local to the user to have these run in a remote data center. The user accesses his or her desktop via remote desktop network protocols. This brings with it new challenges in the performance, i.e. responsiveness, of the desktop as perceived by the user at the end-user device. Besides the efficiency of the desktop remoting protocols themselves, a significant aspect to realizing good performance is the managing of network latency. This calls for not only appropriate network bandwidth but also for finding solutions which keep the served desktops in “close proximity” to the end user, thereby minimizing latency. This is further complicated by mobile users who travel and need to access their desktops from many different geographical locations.

### SUMMARY OF THE INVENTION

Principles of the present invention provide techniques for collocating desktop virtual machines to the proximity of the user. In one aspect, an exemplary method (which can be computer implemented) includes the steps of storing a plurality of master desktop images for a plurality of users at a plurality of geographically diverse data centers; and constructing, at a first one of the data centers, a virtual desktop for a remote client. The virtual desktop is constructed from a given one of the master desktop images at the first one of the data centers in the form of an individualized delta image, which is linked to the master desktop image, for a user associated with the remote client. A further step includes determining that the remote client is at a geographical location wherein the first one of the data centers is not a closest one of the data centers to the remote client. A still further step, responsive to the determining, includes reconstructing, at a second one of the data centers which is closest to the remote client, the virtual desktop for the remote client. The virtual desktop is reconstructed from linking the corresponding master desktop image at the second one of the data centers with the individualized delta image for the user associated with the remote client. A copy of the individualized delta image is moved from the first one of the data centers to the second one of the data centers to facilitate reconstructing the virtual desktop.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

One or more embodiments of the invention or elements thereof can be implemented in the form of a computer product including a computer readable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

One or more embodiments of the invention may offer one or more of the following technical benefits:
reduced latency
as a consequence of reduced latency, the types of applications that can be supported on the end-user devices are expanded; for instance, to allow for a richer user experience by allowing more graphical presentation to traverse the network from the data center to the end-user device, and/or to allow for better performance by having faster data transfer of either applications, data and/or the “remoting” of the application (screen image buffer updates).

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows a block diagram of an exemplary desktop virtualization system, according to an aspect of the invention, with an end user device in a first geographical location;

FIG. 2 shows a block diagram of the exemplary desktop virtualization system of FIG. 1, with the end user device in a second geographical location;

FIG. 3 shows a flow chart of an exemplary method;

FIG. 4 depicts a computer system that may be useful in implementing one or more aspects and/or elements of the invention;

FIG. 5 shows an architecture diagram for an exemplary implementation using a hypervisor;

FIG. 6 shows exemplary movement of a delta file in an environment such as that depicted in FIG. 5; and

FIG. 7 shows a data flow between system components in a non-limiting exemplary virtual desktop environment in which one or more embodiments can be implemented.

### DETAILED DESCRIPTION OF PREFERRED EMBODIMENTS

As noted, desktop virtualization is emerging as an alternative to traditional desktop delivery. The basic concept of desktop virtualization is based on moving the operating system (OS) and application execution from devices which are local to the user to run in a remote data center. The user accesses his or her desktop via remote desktop network protocols. This brings with it new challenges in the performance, i.e. responsiveness, of the desktop as perceived by the user at the end-user device. Besides the efficiency of the desktop remoting protocols themselves, a significant aspect to realizing good performance is the managing of network latency. This calls for not only appropriate network bandwidth but also for finding solutions which keep the served desktops in “close proximity” to the end user, thereby minimizing latency. This is further complicated by mobile users who travel and need to access their desktops from many different geographical locations.

Desktop virtualization involves separating a personal computer desktop environment from the physical end-user machine by using a client-server computing model. The resulting “virtualized” desktop is stored on a remote central server, instead of on the local storage of the end-user machine (client). Accordingly, when users work from their remote desktop client, a majority of the programs, applications, processes, and data used are kept and run centrally off the remote central server, allowing users to access their desktops on a variety of capable devices (e.g., traditional personal computers, notebook computers, smart phones, thin clients, and the like).

In the most general case, the client device may be based upon an entirely different hardware architecture than that used by the projected desktop environment on the central server, and may also be based upon an entirely different operating system.

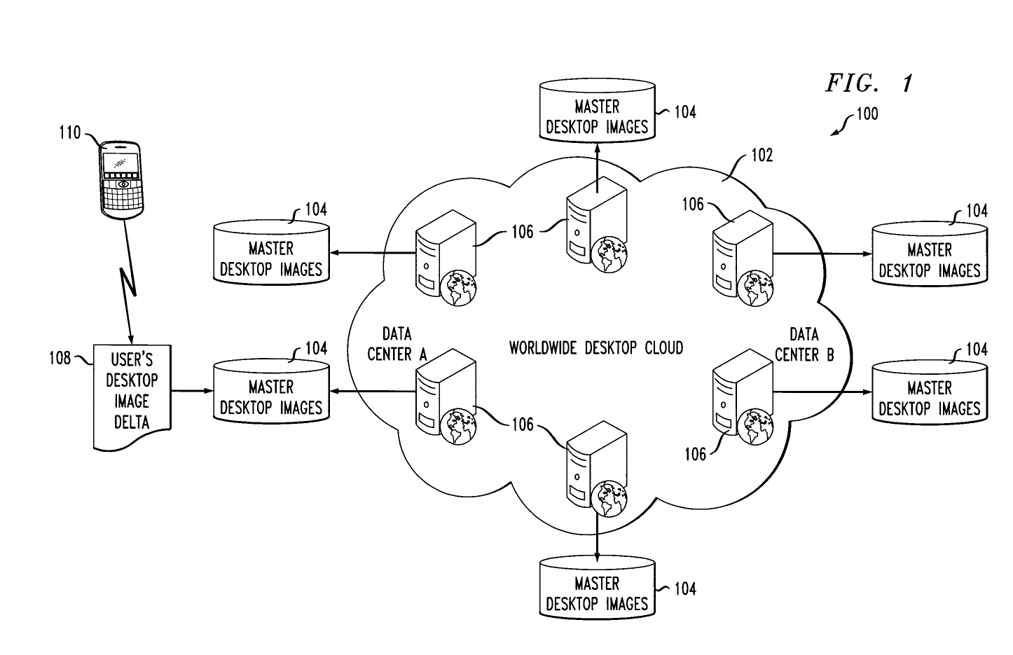

Reference should now be had to exemplary system 100 of FIG. 1. Worldwide desktop cloud 102 includes a plurality of data centers 106, each with one or more servers. One or more embodiments of the invention effectively move the user's desktop image to the hosting data center 106 nearest to the user at the given time. The idea is not to move the complete image as these are potentially large and would require high bandwidth to relocate them. Instead, one or more instances take advantage of the commonality of the base desktop images and locate this base (master) desktop image 104 at each data center 106. The modifications that each user makes to his or her desktop (i.e. differences from the base desktop image) are stored in a “delta” file 108. These delta files, being generally much smaller than the base desktop image, are more readily copied from one data center 106 to another. Since these delta files 108 are based on the common base image 104 that is located at each data center, they can be moved to a data center closest to the current location of the user and used directly to be applied to the base image 104, thus providing the user's desktop in its current state.

The data centers 106 can be interconnected, for example, by the Internet, a suitable wide area network (WAN) (which may comprise an intranet), a virtual private network (VPN), or the like.

In FIG. 1, client (end-user) device 110 is geographically closest to that one of the data centers 106 denoted as “Data Center A.” The client can access the data center, for example, using the Internet, a suitable WAN (which could be different or the same as the one mentioned above) (again, the WAN may comprise an intranet), a VPN (which could be different or the same as the one mentioned above), or the like.

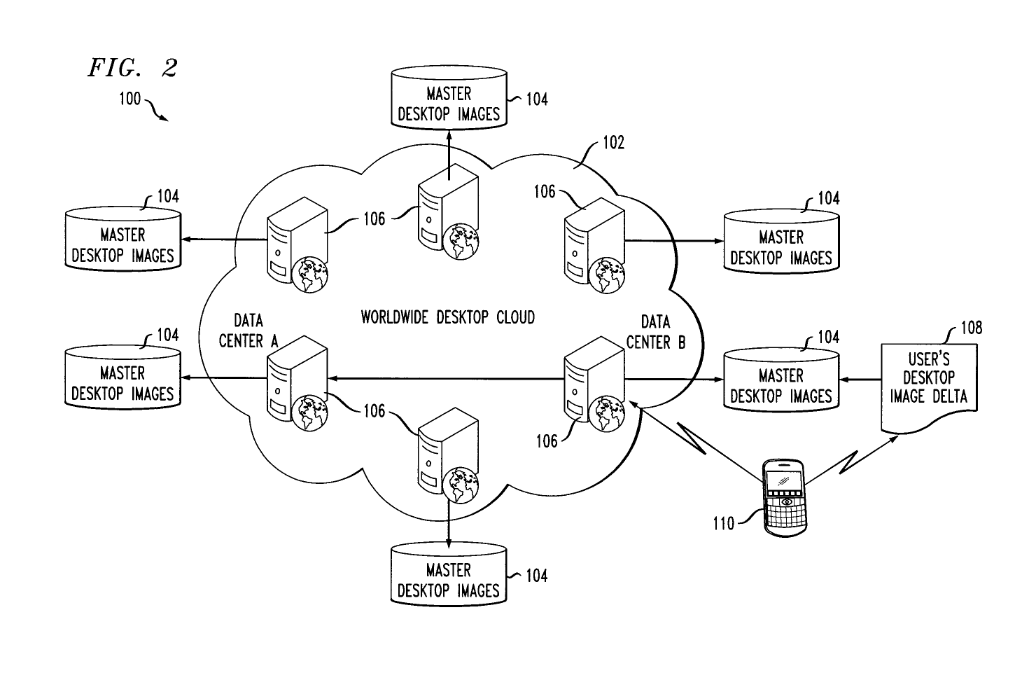

Referring now to FIG. 2, wherein like elements have received the same reference character as in FIG. 1, the client (end-user) device 110 has moved to a different geographic location, closer to that one of the data centers 106 denoted as “Data Center B.” When this situation is detected, Data Center B fetches a copy of the “delta” file 108 from Data Center A.

A number of techniques may be used to determine which data center 106 is the closest to device 110. In some instances, a navigation system (e.g., global positioning system or GPS) is used to determine the navigation system coordinates of the device 110. In other instances, one could know which data center to use by, for example, prompting the user (at the start of a session) for his or her location in terms of latitude and longitude, closest major city and state or foreign country, or “zip” or other postal code, for example.

Delta file 108 can, in theory, include data files, customizations and/or defaults made to the programs, and the like. US Patent Application Publication 2009-0260007 of Beaty et al., the complete disclosure of which is expressly incorporated herein by reference in its entirety for all purposes, provides a detailed description of the use of delta files. Given the teachings herein, the skilled artisan will be able to construct delta files to implement one or more embodiments of the invention, being familiar with same from, for example, the aforesaid Beaty publication and/or the IBM Virtual Storage Optimizer (VSO) solution available from International Business Machines Corporation of Armonk, N.Y., USA. In essence, with regard to the delta file 108, if anything is changed that would normally change the master image, the same is instead written to the delta file.

Data may or may not be part of the delta file. In one model, a user data disk is employed for all things that it is desired to persist (e.g., a network drive). In this case (separate data disk) the data is not part of the image and therefore is not included in the delta file 108. In some instances, the data disk could be moved but in one or more embodiments, only the delta file 108 is moved and a network link to the data (which is on a network drive) is employed. One or more embodiments reduce latency associated with remoting protocols (e.g., RDP—remote desktop protocol or Independent Computing Architecture (ICA) from Citrix Systems, Ft. Lauderdale, Fla., USA). Such protocols provide a display of the desktop on a mobile device, i.e., screen buffer updates. In some cases, personal settings, documents, applications, and the like are in the image, in which case the data and the like are in the delta file 108. In general, any WRITE of any block of data, instead of being written to the master image 104, can be written to the personal delta 108.

As will be discussed in greater detail below, the skilled artisan will appreciate that a connection broker is a resource manager that manages a pool of connections to the remote desktops, enabling rapid reuse of these connections by short-lived processes without the overhead of setting up a new connection each time. It is typical that a portal (of the connection broker) is accessed by the client device 110 to provide credentials which the connection broker uses to connect the device to a virtual desktop or virtual desktop application that the user is entitled to. Preferably, client device 110 can connect to any connection broker instance; however, by providing the location (e.g., location coordinates) to the connection broker the type of movement of the desktop delta image described herein is made possible.

Heretofore, there has been no movement of the virtual desktop delta or master image; in current techniques, the connection broker connects the client to the virtual desktop at a “home” location regardless of where the client was at the time. In one or more embodiments of the invention, the master image, which is a base identical virtual desktop image, is stored globally at the data centers 106. This image is typically large and is not moved frequently. The delta files are changes to the master that a given user has made (usually much smaller). Thus, in one or more embodiments, these smaller deltas 108 are moved from location to location and associated with the same master which resides in all data centers. The master image is a virtual machine image of a desktop, including, for example, an operating system and a common set of applications. The delta files 108 are things changed by the user over what is in the base image.

Aspects of the invention thus provide techniques for collocating a desktop using shared master images with movement of only the delta file 108 (i.e. the file containing the updates of the end-user's virtual desktop image over that of the master image) to have the user's desktop relocated to a data center close to the end-user. A number of techniques can be used to determine which data center is closest to the end-user. By making use of end-user devices which include global positioning system (GPS) functionality to enable determining where “in the world” the user is currently located, the collocation of the user's desktop to the datacenter nearest the user at any given time can be automated. The coordinates are captured from the user's device 110 (thin-clients, hand-held mobile devices, and the like) and sent to the connection broker fabric.

As noted, the skilled artisan will appreciate that a connection broker is a resource manager that manages a pool of connections to the remote desktops, enabling rapid reuse of these connections by short-lived processes without the overhead of setting up a new connection each time. Connection broker fabric is common to virtual desktop solutions to provide authentication and redirection to the virtual desktop in the desktop cloud. The connection broker fabric knows both where the user's desktop is currently located (which data center 106) as well as where all of the datacenters 106 are located by geographical coordinates. The connection broker computes the nearest datacenter 106 and if it is not the same as the current hosting datacenter, it initiates the technique described above to have the user's desktop virtual machine moved to the datacenter computed to be the closest, by moving the delta file 108.

Connection brokers are available from VMware, Inc. of Palo Alto, Calif., USA; the aforementioned Citrix Systems; Desktone, Inc., Chelmsford, Mass., USA; Leostream Corporation, Waltham, Mass., USA, and the like. Storage of the delta file 108 is typically part of a hypervisor layer. Linking the delta to the master is described in the aforementioned Beaty publication. Moving of a delta file 108 is a matter of file copy from one data center (e.g., “A”) to another (e.g., “B”) and linking the delta to the master at the new location.

In some instances, a connection broker can be modified to implement one or more embodiments. In another approach, the techniques described in the aforesaid Beaty publication and/or in the aforementioned IBM Virtual Storage Optimizer (VSO) solution, can be modified to implement one or more embodiments. The connection broker calls for desktops to be listed, so that a connection can be made to them from the underlying hypervisors, which support the virtual machines (desktops). In the approach of the aforesaid Beaty publication, a proxy is employed, and the connection broker “talks” to this proxy rather than directly to the back end hypervisors. In this latter approach, it is not necessary to alter the connection broker; rather, the functionality of one or more embodiments of the invention is coded into a proxy.

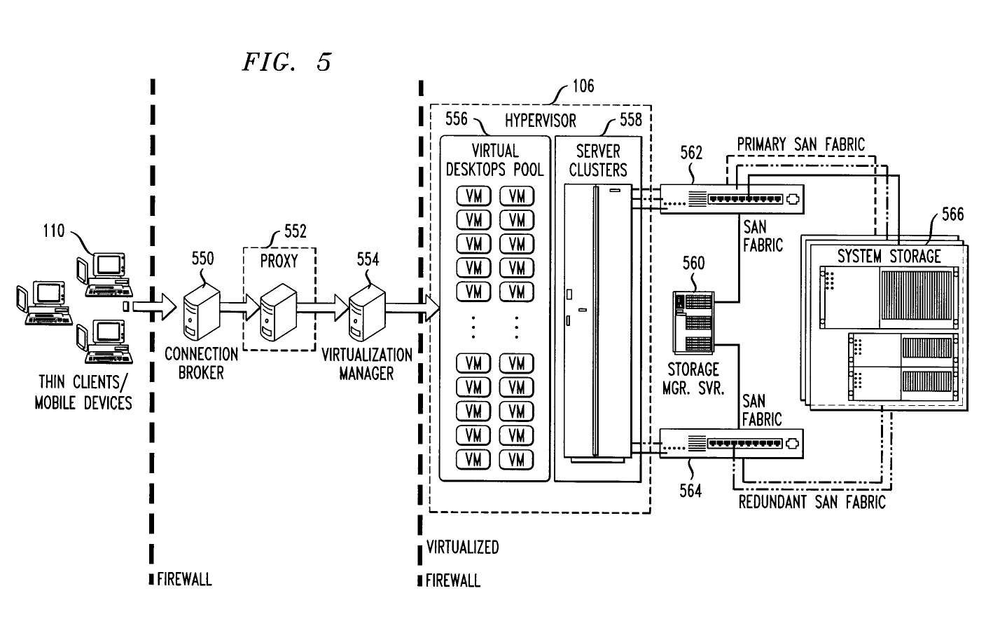

FIG. 5 shows an architecture diagram for an exemplary implementation using a hypervisor. Thin clients or mobile devices, such as 110, interact with connection broker 550 through a first firewall. Connection broker 550 in turn interacts with proxy 552, which itself interacts with virtualization manager 554 (a non-limiting example of which is Virtual Center available from VMWare, Inc.). A second firewall separates virtualization manager 554 from data center 106. In this instance, data center 106 includes a physical server cluster or clusters 558 on which a number of virtual desktops 556 are hosted using suitable hypervisor (platform virtualization) software. A non-limiting example of suitable software is VMWARE® ESX software (registered mark of VMWare, Inc., Palo Alto, Calif., USA). Storage includes a suitable storage manager server 560 (a non-limiting example is IBM Tivoli® Storage Manager software, registered mark of International Business Machines Corporation, Armonk, N.Y., USA)) with primary and redundant storage area network (SAN) fabrics 562, 564 and system storage 566. In a preferred approach, proxy 552 serves to both perform a VSO (Virtual Storage Optimizer) function as well as to carry out location aware computations and coordination of delta file movement.

The GPS coordinates can be captured from the device 110 using known techniques, passed through connection broker 550 and into proxy 552, where the coordinates or other location information (city or zip code, e.g.) can be used to calculate the closest data center.

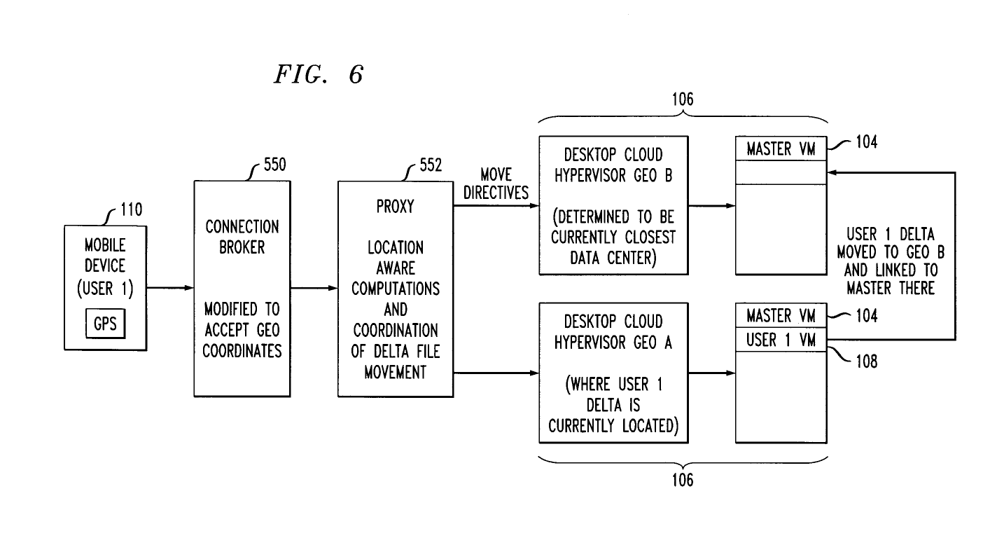

As seen in FIG. 6, location-aware mobile device 110 interacts with connection broker 550, which has been modified to accept geographic (whether GPS or other) coordinates from mobile device 110. Proxy 552 obtains the coordinates from connection broker 550 and carries out the location-aware calculations and coordinates movement of the delta file 108. The delta file 108 for the first user is currently located at that one of the data centers 106 designated as “A.” When proxy 552 issues a move directive, delta file 108 is moved to that one of the data centers 106 designated as “B.”

Elements in FIGS. 5 and 6 similar to those in the other figures have received the same reference character.

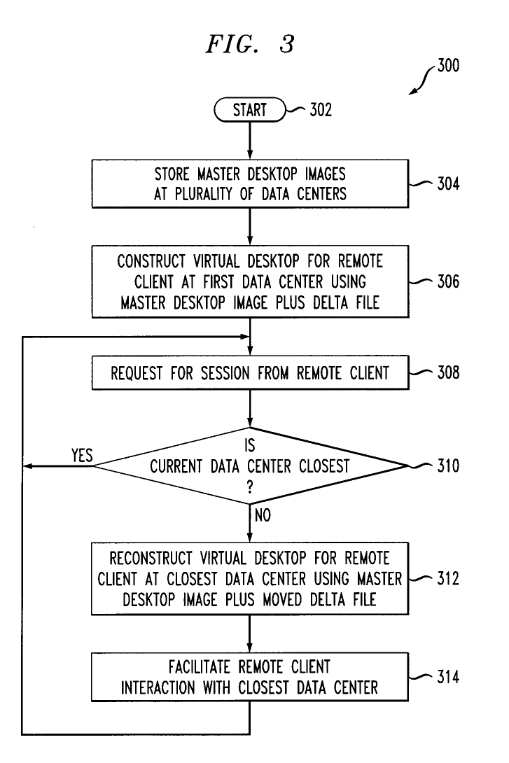

Given the discussion thus far, and with reference now to flow chart 300 of FIG. 3, which begins at block 302, it will be appreciated that, in general terms, a method, according to an aspect of the invention, includes the step 304 of storing a plurality of master desktop images 104 for a plurality of users at a plurality of geographically diverse data centers 106. The master desktop image 104 is a common base virtual machine (virtual desktop) image used by a company (or other entity) or set of users within the company (or other entity). There may be more than one base image used by different sets of users.

The method further includes the step 306 of constructing, at a first one of the data centers (e.g., data center “A”), a virtual desktop for a remote client 110, the virtual desktop being constructed from a given one of the master desktop images 104 at the first one of the data centers and an individualized delta image 108 for a user associated with the remote client 110. A further step 310 includes determining that the remote client 110 is at a geographical location wherein the first one of the data centers is not the closest to the remote client (e.g., data center “B” is now closest, as seen in FIG. 2). The determination in decision block 310 can be carried out in a variety of ways. For example, the well-known “great circle distance” between the remote client 110 and each of the data centers 106 can be calculated and the closest data center determined; if this is not the same as the current data center, block 310 yields a logical “NO.” The latitude and longitude coordinates can be converted to radians for use in the “great circle distance” formula, for example. Where the user is prompted to enter his or her location in terms of city and state or foreign country, the coordinates of major cities can be stored within the connection broker fabric or proxy, for example.

It should also be noted that in some instances, line speed can be factored in, and the determination of “closest” data center is based on the data center with the shortest elapsed time for data to travel between the device 110 and the data center 106, by summing the time for each network link between the device and the given data center for which the elapsed time is to be calculated.

In step 312, responsive to the determining (“YES” branch of block 310), reconstruct, at a second one of the data centers (which is closest to the remote client), the virtual desktop for the remote client. The virtual desktop is reconstructed from a given one of the master desktop images 104 at the second one of the data centers (e.g., data center “B”) and the individualized delta image 108 for the user associated with the remote client. A copy of the individualized delta image 108 is moved from the first one of the data centers to the second one of the data centers to facilitate reconstructing the virtual desktop.

The remote client 110 can then interact with the virtual desktop at the new closest data center, as at step 314.

As seen at optional step 308, in a preferred but non-limiting approach, every time the client 110 seeks to log on (establish a session), check for the closest data center to where the client is, as in block 310; query the hypervisor or proxy as to where the desk top delta 108 currently is and if its location is not closest to where the client is, move delta 108 to the closest data center as per step 312. In an optional approach, the last know position of device 110 could be stored and movement away from the last position could be detected.

In some instances, step 310 is facilitated using navigation system coordinates from the remote client 110 (by way of example and not limitation, GPS coordinates). In general, device 110 may be location aware, GPS being merely one-non-limiting example of same. Whenever a location-aware device seeks to access a virtual desktop, its location can be determined. Other techniques could be used in other cases; e.g., when user logs on to access the virtual desktop, he or she is prompted for his or her current location (e.g., city and state or foreign country; postal code; and the like). Calculations are then performed based on the input location and the known, stored locations of the data centers 106. Each data center 106 may include, for example, code for performing the location and distance calculations, and a data file with the location of each data center, major cities, postal codes, and the like. Such code and data files may be accessed, for example, by the connection broker fabric or proxy to carry out the calculations in block 310.

### Additional Information on VSO Architecture

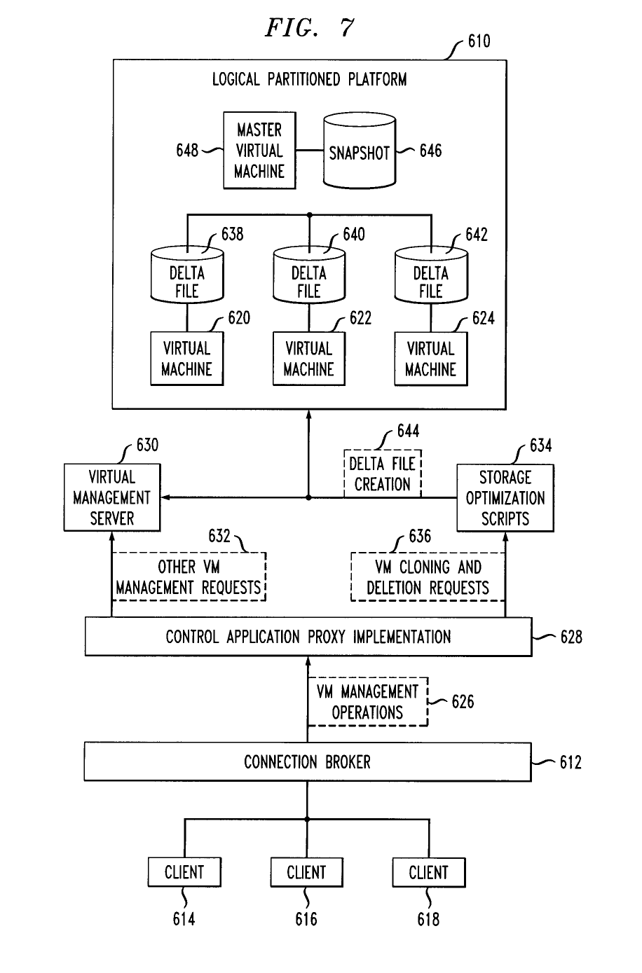

As noted, given the teachings herein, the skilled artisan will be able to construct delta files to implement one or more embodiments of the invention, being familiar with same from, for example, the aforesaid Beaty publication and/or the IBM Virtual Storage Optimizer (VSO) solution available from International Business Machines Corporation of Armonk, N.Y., USA. Nevertheless, FIG. 7, similar to FIG. 6 in the aforesaid Beaty publication, is reproduced herein. Logical partitioned platform 610 is a logically partitioned platform executing on a data processing system, such as described elsewhere herein.

Connection broker 612 manages user connections between clients 614, 616, and 618 and their respective virtual machines 620, 622, and 624 executing on logical partitioned platform 610. Connection broker 612 is a data processing system that manages incoming connection requests, and allocates available virtual machines to the requesting client. Connection broker 612 can also authenticate clients 614, 616, and 618 and direct or assign clients 614, 616, and 618 to one of virtual machines 620, 622, and 624 according to a predefined policy, group membership, or other criteria. Connection broker 612 can also control the state of the virtual desktops 620, 622, and 624, for example, but not limited to, powering the virtual machine on and off, and suspending and resuming the virtual machine. Connection broker 612 can also track the connection status of clients 614, 616, and 618 to their assigned virtual machines, for example, but not limited to, identifying whether a client is currently logged onto a virtual machine, or identifying to which of clients 614, 616, and 618 a virtual machine has been assigned. In one illustrative embodiment, connection broker 612 is a Virtual Desktop Manager®, available from VMWare, Inc.

Virtual machines 620, 622, and 624 are virtual partitioned operating systems within a logical partitioned platform. Virtual machines 620, 622, and 624 are executed within a partition.

Connection broker 612 receives virtual machine management operations 626 from one of clients 614, 616, and 618. Virtual machine management operations 626 are system calls to virtual management server 630. The system calls can be either calls to allocate or delete a virtual machine, such as one of virtual machines 620, 622, and 624 for one of clients 614, 616, and 618, or the system calls can be other system calls related to the operation and management of logical partitioned platform 610. Other system calls can include, for example, authenticating clients, controlling the state of the virtual machines, and tracking the connection status of clients to their assigned virtual machines. In one illustrative embodiment, the calls can be of the standard VMware® Infrastructure SDK.

Control application proxy implementation 628 is a software component that intercepts virtual machine management operations 626 sent from connection broker 612. Control application proxy implementation 628 handles virtual machine management operations 626 as required for provisioning of virtual machines 620, 622, and 624 and then returns the expected result to the caller. Virtual machine management operations 626 can include allocating available virtual machines to the requesting client, authenticating clients, directing or assigning clients to a virtual machine, controlling the state of the virtual machines, tracking the connection status of clients to their assigned virtual machines, and requesting the cloning or deletion of new virtual machines.

Control application proxy implementation 628 acts as both a target and an initiator of VI SDK traffic to connection broker 612 and virtual management server 630. To the virtual management server 630, it appears that virtual management server 630 communicates directly to connection broker 612. To connection broker 612, it appears that connection broker 612 communicates directly to virtual management server 630. By maintaining this appearance of transparency between the virtual management server 630 and the connection broker 612, control application proxy implementation 628 can introduce any new functions desired between the virtual management server 630 and the connection broker 612. In this case, the new function is translating virtual machine clone commands from the virtual management server 630 into virtual machines and delta files.

Virtual machine management operations 626 that are not relevant to the creation or deletion of virtual machines 620, 622, and 624 are transparently passed through to virtualization management server 630. That is, other virtual machine management requests 632 are passed through to virtualization management server 630 unchanged.

Virtual machine management operations 626 that request that a new desktop virtual machine be created, such as one of virtual machines 620, 622, and 624, or that an existing desktop virtual machine be deleted, such as one of virtual machines 620, 622, and 624, triggers Storage Optimization Scripts 634. That is, virtual machine cloning and deletion requests 636 are intercepted by Control application proxy implementation 628 and routed to Storage Optimization Scripts 634.

In one illustrative embodiment for VMware® Infrastructure, Control application proxy implementation 628 intercepts the following VMware® API calls: 1) CloneVM Task—this VMware® API call is redirected to a Storage Optimization Script which creates a desktop virtual machine with a skeleton delta file; 2) DestroyVM Task—this VMware® API call is redirected to a Storage Optimization Script that properly cleans-up the skeleton delta file enabled desktop virtual machine; 3) WaitForUpdates, CheckForUpdates, Cancel WaitForUpdates, QueryOptions, CreateFilter, DestroyPropertyFilter—these VMware® API calls are redirected to Storage Optimization Scripts which obtain proper status of the Clone process of the skeleton delta file enabled desktop virtual machine. In at least some presently preferred forms, the list of API calls can be reduced to the following:

cloneVM_Task
destroy_Task
retrieveServiceContent
queryOptions
login

Storage Optimization Scripts 634 are software processes that execute in conjunction with Control application proxy implementation 628 that oversees the cloning of new virtual desktops, and the deletion of existing virtual desktops. Responsive to receiving a management operation to create a new desktop virtual machine, Storage Optimization Scripts 634 creates one of delta files 638, 640, and 642 for allocation to the new virtual machine. Delta files 638, 640, and 642 are delta files, such as described above. An indication of delta file creation 644 is sent to virtual management server 630.

Virtual management server 630 is the central control node for configuring, provisioning, and managing the virtual machine environments. Virtual management server 630 provisions a partition within Logical partitioned platform 610, in which to execute a new virtual machine, which is one of virtual machines 620, 622, and 624. The new delta file, which is one of delta files 638, 640, and 642, is also provisioned to the new virtual machine.

Instead of virtual management server 630 provisioning an entire operating system to the new desktop virtual machine, virtualization management server points virtual machines 620, 622, and 624 to a snapshot 646 of master virtual machine 648. Master virtual machine 648 is a virtual machine that contains any needed software by a virtual machine for a particular group of clients. Unlike virtual machines 620, 622, and 624, master virtual machine 648 contains the boot disk image and bootable files. Snapshot 646 is a snapshot of master virtual machine 648.

When virtual machines 620, 622, and 624 are subsequently started, virtual machines 620, 622, and 624 by necessity need to write files, such as, for example, but not limited to, log files, registry changes, and saves of user files. These new writes are captured in delta files 638, 640, and 642. Therefore, the new writes do not change the state of snapshot 646 which remains fixed in the same state as of the time of the snapshot 646. Since virtual machines 620, 622, and 624 preferentially refer to the delta files 638, 640, and 642, virtual machines 620, 622, and 624 read the latest versions of data which has changed since the creation of Snapshot 646 from the associated one of delta files 638, 640, and 642. Virtual machines 620, 622, and 624 read data which has not changed since the creation of Snapshot 646 from Snapshot 646.

Clients 614, 616, 618 are analogous to clients 110 in FIG. 5; broker 612 is analogous to broker 550 in FIG. 5; proxy 628 is analogous to proxy 552 in FIG. 5; server 630 is analogous to center 554 in FIG. 5; and block 610 is analogous to block 106 in FIG. 5; however, one or more of the analogous elements in FIG. 5 are modified, as compared to FIG. 7, to implement one or more techniques of the invention as described herein.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

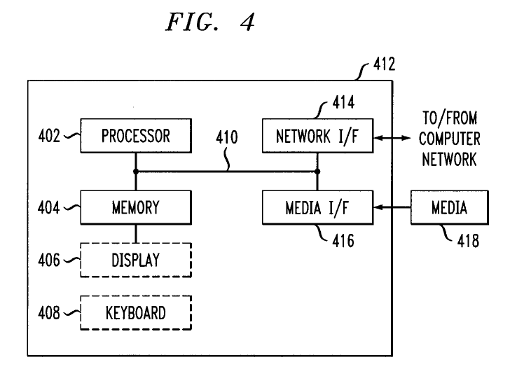

One or more embodiments can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams of FIGS. 1, 2, 5, and 6; by way of example and not limitation, a connection broker module, a proxy module, and a hypervisor module. The method steps can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising the steps of:
storing a plurality of master desktop images for a plurality of users at a plurality of geographically diverse data centers;
constructing, at a first one of said data centers, a virtual desktop for a remote client, said virtual desktop being constructed from a given one of said master desktop images at said first one of said data centers and an individualized delta image for a user associated with said remote client;
determining that said remote client is at a geographical location wherein said first one of said data centers is not a closest one of said data centers to said remote client; and
responsive to said determining, reconstructing, at a second one of said data centers which is closest to said remote client, said virtual desktop for said remote client, said virtual desktop being reconstructed from a given one of said master desktop images at said second one of said data centers and said individualized delta image for said user associated with said remote client, a copy of said individualized delta image being moved from said first one of said data centers to said second one of said data centers to facilitate reconstructing said virtual desktop.

2. The method of claim 1, wherein said determining is carried out using navigation system coordinates from said remote client.

3. The method of claim 2, wherein, in said determining step, said navigation system coordinates comprise global positioning system coordinates.

4. The method of claim 1, wherein said determining is carried by querying a user of said remote client.

5. The method of claim 1, wherein said determining is carried out in connection with a request from said remote client to establish a session with said first one of said data centers.

6. The method of claim 1, wherein said determining is based on a shortest elapsed time for data to travel between said remote client and given ones of said data centers.

7. The method of claim 1, wherein said determining is based on geographic distance between said remote client and given ones of said data centers.

8. The method of claim 1, further comprising providing a system, wherein the system comprises distinct software modules, each of the distinct software modules being embodied on a computer-readable storage medium, and wherein the distinct software modules comprise a proxy module, a hypervisor module, and a connection broker module;
wherein:
said storing is facilitated by at least one of said proxy module and said hypervisor module executing on at least one hardware processor;
said constructing is facilitated by at least one of said proxy module and said hypervisor module executing on said at least one hardware processor;
said determining is carried out by said proxy module executing on said at least one hardware processor, in response to a request passed from said connection broker module; and
said reconstructing is facilitated by at least one of said proxy module and said hypervisor module executing on said at least one hardware processor.

9. A computer program product comprising a computer readable storage medium having computer readable program code embodied therewith, said computer readable program code comprising:
computer readable program code configured to store a plurality of master desktop images for a plurality of users at a plurality of geographically diverse data centers;
computer readable program code configured to construct, at a first one of said data centers, a virtual desktop for a remote client, said virtual desktop being constructed from a given one of said master desktop images at said first one of said data centers and an individualized delta image for a user associated with said remote client;
computer readable program code configured to determine that said remote client is at a geographical location wherein said first one of said data centers is not a closest one of said data centers to said remote client; and
computer readable program code configured to, responsive to said determining, reconstruct, at a second one of said data centers which is closest to said remote client, said virtual desktop for said remote client, said virtual desktop being reconstructed from a given one of said master desktop images at said second one of said data centers and said individualized delta image for said user associated with said remote client, a copy of said individualized delta image being moved from said first one of said data centers to said second one of said data centers to facilitate reconstructing said virtual desktop.

10. The computer program product of claim 9, wherein said computer readable program code configured to determine employs navigation system coordinates from said remote client.

11. The computer program product of claim 10, wherein said navigation system coordinates comprise global positioning system coordinates.

12. The computer program product of claim 9, wherein said computer readable program code configured to determine comprises computer readable program code configured to query a user of said remote client.

13. The computer program product of claim 9, wherein said computer readable program code configured to determine is responsive to a request from said remote client to establish a session with said first one of said data centers.

14. The computer program product of claim 9, wherein said computer readable program code configured to determine bases said determination at least on a shortest elapsed time for data to travel between said remote client and given ones of said data centers.

15. The computer program product of claim 9, wherein said computer readable program code configured to determine bases said determination at least on geographic distance between said remote client and given ones of said data centers.

16. An apparatus comprising:
a memory; and
at least one processor, coupled to said memory, and operative to:
store a plurality of master desktop images for a plurality of users at a plurality of geographically diverse data centers;
construct, at a first one of said data centers, a virtual desktop for a remote client, said virtual desktop being constructed from a given one of said master desktop images at said first one of said data centers and an individualized delta image for a user associated with said remote client;
determine that said remote client is at a geographical location wherein said first one of said data centers is not a closest one of said data centers to said remote client; and
responsive to said determining, reconstruct, at a second one of said data centers which is closest to said remote client, said virtual desktop for said remote client, said virtual desktop being reconstructed from a given one of said master desktop images at said second one of said data centers and said individualized delta image for said user associated with said remote client, a copy of said individualized delta image being moved from said first one of said data centers to said second one of said data centers to facilitate reconstructing said virtual desktop.

17. The apparatus of claim 16, wherein said at least one processor is operative to determine by employing navigation system coordinates from said remote client.

18. The apparatus of claim 17, wherein said navigation system coordinates comprise global positioning system coordinates.

19. The apparatus of claim 16, wherein said at least one processor is operative to determine by querying a user of said remote client.

20. The apparatus of claim 16, wherein said at least one processor is operative to determine responsive to a request from said remote client to establish a session with said first one of said data centers.

21. The apparatus of claim 16, wherein said at least one processor is operative to base said determination at least on a shortest elapsed time for data to travel between said remote client and given ones of said data centers.

22. The apparatus of claim 16, wherein said at least one processor is operative to base said determination at least on a geographic distance between said remote client and given ones of said data centers.

23. The apparatus of claim 16, further comprising a plurality of distinct software modules, each of the distinct software modules being embodied on a computer-readable storage medium, and wherein the distinct software modules comprise a proxy module, a hypervisor module, and a connection broker module;
wherein:
said at least one processor is operative to facilitate storing by executing at least one of said proxy module and said hypervisor module;
said at least one processor is operative to facilitate constructing by executing at least one of said proxy module and said hypervisor module;
said at least one processor is operative to determine by executing said proxy module; and
said at least one processor is operative to facilitate reconstructing by executing at least one of said proxy module and said hypervisor module.

24. An apparatus comprising:
means for storing a plurality of master desktop images for a plurality of users at a plurality of geographically diverse data centers;
means for constructing, at a first one of said data centers, a virtual desktop for a remote client, said virtual desktop being constructed from a given one of said master desktop images at said first one of said data centers and an individualized delta image for a user associated with said remote client;
means for determining that said remote client is at a geographical location wherein said first one of said data centers is not a closest one of said data centers to said remote client; and
means, responsive to said determining, for reconstructing, at a second one of said data centers which is closest to said remote client, said virtual desktop for said remote client, said virtual desktop being reconstructed from a given one of said master desktop images at said second one of said data centers and said individualized delta image for said user associated with said remote client, a copy of said individualized delta image being moved from said first one of said data centers to said second one of said data centers to facilitate reconstructing said virtual desktop.

25. The apparatus of claim 24, wherein said means for determining employ navigation system coordinates from said remote client.
